(19) United States
(12) Patent Application Publication
(10) Pub. No.: US 2007/0244019 A1
(43) Pub. Date: Oct. 18, 2007

(54) Water-based paint stripper

(75) Inventors: Marvin Detar, Wickliffe, OH (US); Frederick Connelly, North Canton, OH (US)

Correspondence Address: SAND & SEBOLT, AEGIS TOWER, SUITE 1100, 4940 MUNSON STREET, NW, CANTON, OH, 44718-3615, US

(73) Assignee: STAR BRONZE COMPANY, INC., Alliance, OH (US)

(21) Appl. No.: 11/811,627

(22) Filed: Jun. 11, 2007

Related U.S. Application Data
(63) Continuation of application No. 10/891,947, filed on Jul. 15, 2004, now abandoned.
(60) Provisional application No. 60/487,755, filed on Jul. 15, 2003.

(51) Int. Cl. C09D 9/04

(52) U.S. Cl. 510/206

(57) ABSTRACT

A composition comprising from about 5 to about 85 percent by weight aromatic alcohol, from about 5 to about 85 percent by weight water, and from about 0.05 to about 30 percent by weight electrolyte, based upon 100 percent by weight of the total composition where the composition is devoid of hydrogen peroxide.

### CROSS REFERENCE TO RELATED APPLICATIONS

The application is a continuation of U.S. Ser. No. 10/891,947, filed on Jul. 15, 2004, which claims the benefit of U.S. Provisional Application Ser. No. 60/487,755, filed on Jul. 15, 2003.

### FIELD OF THE INVENTION

This invention is directed toward water-based paint stripper compositions.

### BACKGROUND OF THE INVENTION

The removal of paint from various substrates has historically been accomplished by the use of strong acids or bases or halocarbon solvent-based compositions. Because these compositions can be deleterious to health and environment, aqueous or water-based paint stripper compositions have been developed.

For example, U.S. Pat. Nos. 5,728,666 and 6,165,957 teach compositions that include an aromatic alcohol, a hydroxycarboxylic acid, and a peroxide generator in deionized or distilled water. These patents teach the use of deionized or distilled water, which has a high dielectric constant. This has a positive effect in separating charged areas, thus allowing other solvents in the formulation to soften the paint film.

In a similar fashion, U.S. Pat. Nos. 6,200,940 and 6,465,405 teach aqueous-based compositions that comprise an aromatic alcohol, malic acid, and water. These patents teach that the pH of these compositions ranges from about 2 to about 3.

U.S. Patent No. 5,542,986 teaches an aqueous-based paint stripper formulation that includes a benzyl formate ester. The ester is formed when benzyl alcohol is reacted with formic acid.

Due to the strong preference, and in many situations governmental requirements, to employ aqueous-based paint strippers in lieu of solvent-based strippers, there is a need to further develop and improve upon aqueous-based paint stripper formulations.

### SUMMARY OF THE INVENTION

In general the present invention provides composition comprising from about 5 to about 85 percent by weight aromatic alcohol, from about 5 to about 85 percent by weight water, and from about 0.05 to about 30 percent by weight electrolyte, based upon 100 percent by weight of the total composition where the composition is devoid of hydrogen peroxide.

The present invention also includes an aqueous-based paint stripper composition comprising from about 5 to about 85 percent by weight aromatic alcohol, from about 5 to about 85 percent by weight water, and from about 0.05 to about 30 percent by weight electrolyte where the pH of the composition is greater than 7.0.

The present invention further provides an aqueous-based paint stripper composition comprising from about 5 to about 85 percent by weight aromatic alcohol, from about 5 to about 85 percent by weight water, and from about 0.05 to about 30 percent by weight sodium bicarbonate.

The present invention also includes a method for removing paint from a substrate, the method comprising applying an aqueous-based paint stripper formulation to a substrate where the aqueous-based paint stripper formulation includes from about 5 to about 85 percent by weight aromatic alcohol, from about 5 to about 85 percent by weight water, from about 0.05 to about 30 percent by weight electrolyte, from about 0.02 to about 35 percent by weight surfactant, and from about 0.02 to about 10 percent by weight thixotrope, based upon 100 percent by weight of the total composition.

The present invention further includes a composition that is useful for lifting paint from a substrate, when the composition is of the type that is aqueous-based and includes an aromatic alcohol and water, the improvement comprising the addition of an electrolyte to the composition in order to increase the ionic character of the composition.

These formulations are advantageously effective without the use of hydrogen peroxide or hydrogen peroxide yielding compounds. This eliminates safety concerns and increased costs associated with the use of hydrogen peroxide. Also, the ionic character of the formulations may be increased by using salts. The pH of the formulations can be tailored. Accordingly, the aqueous-based paint stripper formulations of this invention can be adjusted between a pH of about 2 and about 11. This is advantageous, for example, where paint is removed from metal substrates, because neutral or alkaline solutions will cause less metal corrosion than acidic solutions.

### DETAILED DESCRIPTION OF ILLUSTRATIVE EMBODIMENTS

The discovery that increasing the ionic character of aqueous paint stripper formulations including aromatic alcohols has led to the development of improved formulations. The aqueous-based paint stripper formulations of this invention include water, an aromatic alcohol, and an electrolyte. Optional ingredients employed in preferred embodiments may include surfactants, thixotropes, preservatives, and corrosion inhibitors. Hydrogen peroxide or compounds that yield hydrogen peroxides may also be employed, although the preferred compositions of this invention are devoid of hydrogen peroxide or compounds that yield hydrogen peroxide. Also, the aqueous-based paint stripper formulations of this invention can be used in place of formulations that have volatile organic vapors that can be unsafe or prohibitive. Indeed, the preferred paint-stripper formulations of this invention are devoid of additional petroleum distillates that are known to cause environmental concern.

Numerous aromatic alcohols are generally known and are useful. Mixtures of these aromatic alcohols can likewise be employed. Useful aromatic alcohols can be defined by the formulas I or II 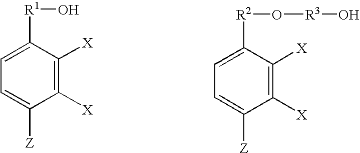
where each X, Y, and Z is independently hydrogen or a hydrocarbyl group, R¹ is a covalent bond or a hydrocarbylene group, R² is a covalent bond or a hydrocarbylene group, and R³ is a hydrocarbylene group.

The hydrocarbyl groups include, but are not limited to, alkyl, cycloalkyl, substituted cycloalkyl, alkenyl, cycloalkenyl, substituted cycloalkenyl, aryl, allyl, substituted aryl, aralkyl, alkaryl, and alkynyl groups, with each group preferably containing from 1 carbon atom, or the appropriate minimum number of carbon atoms to form the group, up to 20 carbon atoms. These hydrocarbyl groups may contain heteroatoms such as, but not limited to, nitrogen, oxygen, silicon, sulfur, and phosphorus atoms.

The hydrocarbylene groups include, but are not limited to, alkylene, cycloalkylene, substituted alkylene, substituted cycloalkylene, alkenylene, cycloalkenylene, substituted alkenylene, substituted cycloalkenylene, arylene, and substituted arylene groups, with each group preferably containing from 1 carbon atom, or the appropriate minimum number of carbon atoms to form the group, up to 20 carbon atoms. These hydrocarbylene groups may contain heteroatoms such as, but not limited to, nitrogen, oxygen, silicon, sulfur, and phosphorus atoms.

Preferably, at least two of X, Y, and Z are hydrogen, and more preferably X, Y, and Z are each hydrogen. Where at least two of X, Y, and Z are hydrogen, the remaining substituent (i.e., X, Y, or Z) is preferably a short-chain alkyl group such as methyl, ethyl, or propyl.

Examples of useful aromatic alcohols include benzyl alcohol, phenethyl alcohol, 2-phenyl-2-propanol, 1-phenyl-2-propanol, ortho, meta, and para-C1-C8 benzyl alcohols, alpha-methyl benzyl alcohol, 1-phenyl-1-propanol, benzoin, and hydrobenzoin.

Deionized or distilled water may be employed, although municipal sources of water are preferred inasmuch as they generally have some degree of ionic character, which is believed to give rise to some of the advantages of the compositions of this invention. Softened water or hard water may be used.

Numerous electrolytes can be employed including both solid and liquid electrolytes. Types of electrolytes include acids, bases, and salts.

Useful acids include both organic and inorganic acids. Examples of organic acids include both saturated and unsaturated acids and diacids. Examples of useful organic acids include sorbic acid, hexanoic acid, pentanoic acid, butyric acid, caprylic acid, heptanoic acid, propionic acid, crotonic acid, benzoic acid, malic, tartaric acid, citric acid, formic acid, lactic acid, acetic acid, oxalic acid, succinic acid, maleic acid, fumaric acid, monomethyl maleate, monomethyl fumarate, monomethyl succinate, other mono C₂-C₂₄ alkyl esters of C₂ through C₁₂ diacids, phthalic acid, monomethylphthalic acid, citric acid, ascorbic acid, erythorbic acid and mono and di C₂-C₂₄ alkyl esters of C₄ through C₁₂ triacids. Examples of inorganic acids include HF, HCl, HBr, HI, HNO₃, boric acid, sulfuric acid, phosphoric acid.

Useful bases include Group IA and Group IB hydroxides and ammonium hydroxide(s). Useful salts include both organic and inorganic salts. Useful organic salts include Group IA, Group IB and ammonium salts of the above mentioned acids. A preferred example of such a salt would include sodium acetate (both anhydrous and hydrated).

Useful inorganic salts include Group IA, IB and ammonium salts of Group VII elements, of bicarbonate and carbonates, of metasilicates and of phosphates, pyrophosphates and polyphosphates. In a preferred embodiment, sodium bicarbonate is employed as the electrolyte.

In certain embodiments, particularly where salts are employed, the pH of the aqueous-based formulations of this invention can be tailored. This is advantageous, for example, where paint is removed from metal substrates, because neutral or alkaline solutions will cause less metal corrosion than acidic solutions. In one or more preferred embodiments, the pH of the aqueous-based solutions of this invention is adjusted above 7.0, preferably above 7.5, even more preferably above 8.0, and most preferably between 8.2 and 8.7 at room temperature.

The composition may include other adjuvants such as coupling agents, stabilizers, chelating agents, corrosion inhibitors, preservatives, rheology modifying agents or thixotropes, evaporation retardants, solubilizer-emulsifiers or surfactants, and any combination of any of the foregoing.

Suitable surfactants or solubilizer-emulsifiers include, but are not limited to, ionic and nonionic surfactants. Example include fluorinated alkyl esters; polyethoxylated sorbitan esters, sorbitan esters, block polymers of ethylene and propylene oxides, alkylphenol polyethoxylates, surfactants that are generally known in the art and are listed in “Surfactants” in Kirk-Othmer Encyclopedia of Chemical Technology, 4th Ed., vol. 23, pp. 478-541 (1997) and references cited therein, and any combination of any of the foregoing. The preferred surfactants have an HLB of between 1 and 10. Examples of sorbitan esters include polyethoxylated sorbitan monolaurate, polyethoxylated sorbitan monopalmitate, polyethoxylated sorbitan monostearate, polyethoxylated sorbitan tristearate, and polyethoxylated sorbitan monooleate; trioleate polysorbates. A preferred surfactant is a nonylphenol polyethoxylate, which is commercially available under the tradename Tergitol™ NP4 (Dow Chemical; Midland, Mich.).

Suitable rheology modifying agents include, but are not limited to, hydroxypropyl cellulose, hydroxypropyl methyl cellulose, hydroxyethyl cellulose, fumed silica, precipitated silica, precipitated calcium carbonate, clays or organoclays, castor oil, castor oil derivatives, and any combination of any of the foregoing. A preferred thixotrope is hydroxyethyl cellulose, which is commercially available under the tradename Cellosize™ Hydroxyethyl Cellulose (Dow Chemical; Midland, Mich.).

In certain embodiments, petrolatum or derivatives thereof are employed. As those skilled in the art appreciate, petrolatum includes semisolid or liquid mixtures of hydrocarbons derived by distillation of paraffin-based petroleum fractions. The solid form (mineral jelly) may be watered-white or pale yellow. The liquid form typically includes white mineral oil. Mixtures of the solid, liquid, and semisolid forms may also be used. It has been found that the petrolatum provides many advantageous properties to the composition in addition to its rheology modifying impact. Accordingly, in certain embodiments, the petrolatum may be employed in combination with other agents, particularly rheology modifying agents, such as hydroxyethyl cellulose.

Suitable corrosion inhibitors include, but are not limited to, benzotriazoles, such as 2-mercaptobenzotriazole, toluoltriazole, benzotriazole, 2(3H)-benzothiazolethione; borates; petroleum sulfonates, corrosion inhibitors that are generally known in the art and are listed in “Corrosion and Corrosion Control” in Kirk-Othmer Encyclopedia of Chemical Technology, 4th Ed., vol. 7, pp. 548-572 (1993) and references cited therein; and any combination of any of the foregoing. A preferred corrosion inhibitor is a benzotriazole, which is commercially available under the tradename Preventol™ CI 8-100 (Bayer Corporation; Pittsburgh, Pa.). Another preferred corrosion inhibitor is disodium 2,5-dimercapto-1,3,4-thiadiazole (30% in water), which is commercially available under the tradename Van-Chem™ NATD (R. T. Vandebilt; Norwalk, Conn.).

The compositions of this invention generally includes from about 5 to about 85 percent by weight water, from about 5 to about 85 percent by weight aromatic alcohol, and from about 0.05 to about 30 percent by weight electrolyte based upon 100% weight of the total composition. Preferably, the composition of this invention includes from about 10 to about 80 percent by weight water, from about 8 to about 80 percent by weight aromatic alcohol, and from about 0.1 to about 27 percent by weight electrolyte based upon 100% weight of the total composition. More preferably, the composition of this invention include from about 12 to about 75 percent by weight water, from about 12 to about 75 percent by weight aromatic alcohol, and from about 0.2 to about 25 percent by weight electrolyte based upon 100% weight of the total composition. Still more preferably, the composition of this invention include from about 15 to about 75 percent by weight water, from about 15 to about 75 percent by weight aromatic alcohol, and from about 0.5 to about 23 percent by weight electrolyte. In one or more embodiments, it has unexpectedly been found that increased water content of the aqueous-based formulations of this invention provide for improved results. Accordingly, in certain embodiments, the aqueous-based formulations include in excess of about 50% by weight water, more preferably in excess of about 60% by weight water, more preferably in excess of about 65% by weight water, and even more preferably from about 70% to about 80% by weight water.

When employed, the compositions of this invention will include from about 0.02 to about 35, more preferably from about 0.04 to about 33, and even more preferably from about 0.05 to about 31 percent by weight surfactant based upon 100% weight of the total composition.

When employed, the compositions of this invention will include from about 0.02 to about 10, more preferably from about 0.04 to about 8, and even more preferably from about 0.05 to about 6 percent by weight thixotrope based upon 100% weight of the total composition.

When employed, the compositions of this invention will include from about 0.001 to about 1, more preferably from about 0.005 to about 0.75, and even more preferably from about 0.01 to about 0.5 percent by weight corrosion inhibitor.

As noted above, the composition of this invention is a mixture of hydrophilic ingredients (e.g., water and electrolytes) and hydrophobic ingredients (e.g., aromatic alcohols). In a preferred embodiment, the mixtures are emulsions or dispersions. The electrolytes and other hydrophilic ingredients are preferably dissolved in the water phase. The aqueous phase is dispersed, emulsified or partitioned into the hydrophobic phase.

In one embodiment of the present invention, the composition includes benzyl alcohol, water, nonylphenol polyethoxylate, sorbic acid, and hydroxyethyl cellulose. Preferably, this composition will include from about 8 to about 80 percent by weight benzyl alcohol, from about 10 to about 90 percent by weight water, from about 0.01 to about 30 percent by weight nonylphenol polyethoxylate, from about 0.01 to about 30 percent by weight sorbic acid, and from about 0.02 to about 5 percent by weight hydroxyethyl cellulose. More preferably, this composition will include from about 15 to about 70 percent by weight benzyl alcohol, from about 15 to about 70 percent by weight water, from about 0.05 to about 27 percent by weight nonylphenol polyethoxylate, from about 0.05 to about 25 percent by weight sorbic acid, and from about 0.05 to about 4 percent by weight hydroxyethyl cellulose.

In another embodiment, of the present invention, the composition includes benzyl alcohol, water, nonylphenol polyethoxylate, sorbic acid, hydroxyethyl cellulose, benzotriazole, and sodium hydroxide. Preferably, this composition will include from about 8 to about 80 percent by weight benzyl alcohol, from about 10 to about 90 percent by weight water, from about 0.01 to about 30 percent by weight nonylphenol polyethoxylate, from about 0.01 to about 30 percent by weight sorbic acid, from about 0.02 to about 5 percent by weight hydroxyethyl cellulose, from about 0.02 to about 5 percent by weight benzotriazole, and from about 0.05 to about 7 percent by weight sodium hydroxide. More preferably, this composition will include from about 15 to about 70 percent by weight benzyl alcohol, from about 15 to about 70 percent by weight water, from about 0.05 to about 27 percent by weight nonylphenol polyethoxylate, from about 0.05 to about 4 percent by weight sorbic acid, from about 0.05 to about 4 percent by weight hydroxyethyl cellulose, from about 0.05 to about 4 percent by weight benzotriazole, and from about 0.1 to about 5 percent by weight sodium hydroxide.

In another embodiment, of the present invention, the composition includes benzyl alcohol, water, nonylphenol polyethoxylate, sodium acetate (trihydrate), hydroxyethyl cellulose, disodium 2,5-dimercapto-1,3,4-thiadiazole (30% in water), and sodium hydroxide. Preferably, this composition will include from about 8 to about 80 percent by weight benzyl alcohol, from about 10 to about 90 percent by weight water, from about 0.01 to about 30 percent by weight nonylphenol polyethoxylate, from about 0.1 to about 25 percent by weight sodium acetate (trihydrate), from about 0.02 to about 5 percent by weight hydroxyethyl cellulose, and from about 0.02 to about 5 percent by weight disodium 2,5-dimercapto-1,3,4-thiadiazole (30% in water). More preferably, this composition will include from about 15 to about 70 percent by weight benzyl alcohol, from about 15 to about 70 percent by weight water, from about 0.05 to about 27 percent by weight nonylphenol polyethoxylate, from about 0.5 to about 20 percent by weight sodium acetate (trihydrate), from about 0.05 to about 4 percent by weight hydroxyethyl cellulose, and from about 0.05 to about 4 percent by weight disodium 2,5-dimercapto-1,3,4-thiadiazole (30% in water).

In another embodiment, of the present invention, the composition includes benzyl alcohol, water, nonylphenol polyethoxylate, sorbic acid, sodium metabisulfite, hydroxyethyl cellulose, disodium 2,5-dimercapto-1,3,4-thiadiazole(30% in water), and sodium hydroxide. Preferably, this composition will include from about 8 to 80 percent benzyl alcohol, from about 10 to 90 percent water, from about 0.01 to 30 percent nonylphenol polyethoxylate, from about 0.01 to 30 percent sorbic acid, from about 0.0003 to 0.3 percent sodium metabisulfite, from about 0.02 to 5 percent hydroxyethyl cellulose, from about 0.02 to 5 percent disodium 2,5-dimercapto-1,3,4-thiadiazole (30% in water), and from about 0.05 to 7 percent sodium hydroxide. More preferably, this composition will include from about 15 to 70 percent benzyl alcohol, from about 15 to 70 percent water, from about 0.05 to 27 percent nonylphenol polyethoxylate, from about 0.05 to 27 percent sorbic acid, from about 0.003 to 0.2 percent sodium metabisulfite, from about 0.05 to 4 percent hydroxyethyl cellulose, from about 0.05 to 4 percent disodium 2,5-dimercapto-1,3,4-thiadiazole (30% in water), and from about 0.1 to 5 percent sodium hydroxide.

In yet another embodiment, the composition includes benzyl alcohol, water, sodium bicarbonate, hydroxyethyl cellulose, a nonionic surfactant, and petrolatum. Preferably, this composition includes from about 5 to about 50% by weight benzyl alcohol, from about 25 to about 80% by weight water, and from about 0.01 to about 25% by weight sodium bicarbonate, from about 0.1 to about 3% by weight hydroxyethyl cellulose, from about 0.01 to about 35% by weight nonionic surfactant, and from about 0.01 to about 10% by weight petrolatum. More preferably, the composition includes from about 10 to about 45 % by weight benzyl alcohol, from about 30 to about 70% by weight water, and from about 0.2 to about 20% by weight sodium bicarbonate, from about 0.15 to about 2.5% by weight hydroxyethyl cellulose, from about 0.02 to about 33% by weight nonionic surfactant, and from about 0.02 to about 8% by weight petrolatum.

The preparation of the present invention is typically performed by adding the solids to the liquids while stirring, reserving the addition of the thixotrope and optional pH adjustment. Other orders of addition are also feasible depending upon the equipment employed.

The paint stripper formulations of this invention may be used in a manner that conventional paint strippers have been used. For example, the paint strippers of this invention can be applied by brushing, spraying, or rolling. Also, they can be applied to a substrate under ambient conditions. In one preferred, although optional, embodiment, the paint stripper formulations of this invention are applied to a painted substrate and the coating formed by the formulations of this invention is then covered. Preferably, the material used to cover the coating will prevent evaporation of the ingredients within the formulation. In one preferred embodiment, a polyethylene film is applied to the coating.

It is preferred that the amount of formulation applied to the substrate be enough to maintain a wet surface until the paint being removed is lifted. This should generally require one application, although several applications may be required. Ideally, the coating is applied in a thickness from about 2 to about 300 mils, more preferably from about 4 to about 200 mils, more preferably from about 6 to about 100 mils, and even more preferably from about 8 to about 50 mils.

In order to demonstrate the practice of the present invention, the following examples have been prepared and tested. The examples should not, however, be viewed as limiting the scope of the invention. The claims will serve to define the invention.

### EXAMPLES

### Example 1

Benzyl alcohol (16.8 grams), tap water (31 grams), and nonylphenol polyethoxylate, (Tergitol® NP-4, 0.06 grams) were stirred under ambient conditions while sorbic acid (1.20 grams) and hydroxyethyl cellulose (Cellosize® QP-30000H (0.60 grams) were added. After three hours of stirring the preparation became viscous and appeared as a soft, colorless to a light cream colored thixotropic paste. The product removed white paint from a metal panel in 70 minutes at 72° F. The product removed paint from a wood surface in less than 30 minutes. The product removed paint from a concrete surface in less than 50 minutes.

### Example 2

Benzyl alcohol (18.0 grams), tap water (29.07 grams), and nonylphenol polyethoxylate, (Tergitol® NP-4, 0.07 grams) were stirred under ambient conditions while sorbic acid (2.04 grams), benzotriazole (Preventol® CI 8-100, 0.21 grams), sodium hydroxide (50% solution, 0.26 grams) and hydroxyethyl cellulose (Cellosize® QP-100MH, 0.35 grams) were added. After three hours of stirring the preparation became viscous and appeared as a soft, colorless to a light cream colored, thixotropic paste. The product removed white paint from a metal panel in 98 minutes at 71° F. The product removed paint from a wood surface in less than 30 minutes. The product removed paint from a concrete surface in less than 50 minutes.

### Example 3

To a stirred preparation of benzyl alcohol (19.0 grams), tap water (28.5 grams), sodium acetate trihydrate (Baker Chemicals, 2.03 grams) nonylphenol polyethoxylate, (Tergitol® NP-4, 0.07 grams), and disodium 2,5-dimercapto-1,3,4-thiadiazole (Vanchem® NATD, 30% in water, 0.07 grams) was added hydroxyethyl cellulose (Cellosize® QP-100MH, 0.35 grams). After three minutes of stirring under ambient conditions the preparation became viscous and appeared as a soft, colorless to a light cream colored, thixotropic paste. This product removed white paint from a metal panel in 89 minutes at 72° F. The product removed paint from a wood surface in less than 30 minutes. The product removed paint from a concrete surface in less than 50 minutes.

### Example 4

To a stirred preparation of benzyl alcohol (15.0 grams), tap water (25.0 grams), nonylphenol polyethoxylate, (Tergitol® NP-4, 0.03 grams), sorbic acid (4.00 grams), sodium metabisulfite (0.02 grams), and disodium 2,5-dimercapto-1,3,4-thiadiazole (Vanchem® NATD, 30% in water, 0.06 grams) was added sodium hydroxide (50% solution, 3.08 grams) and hydroxyethyl cellulose (Cellosize® QP-100MH, 0.34 grams). This preparation appeared opaque until after most of the sodium hydroxide was added under ambient conditions. After the addition of the last ingredient, the product was a clear, bright to slightly orange semiviscous fluid. This product removed white paint from a metal panel in 140 minutes at 71° F. The product removed paint from a wood surface in less than 30 minutes. The product removed paint from a concrete surface in less than 50 minutes.

Various modifications and alterations that do not depart from the scope and spirit of this invention will become apparent to those skilled in the art. This invention is not to be duly limited to the illustrative embodiments set forth herein.

### Example 5

To a stirred preparation of benzyl alcohol (1163 grams), tap water (2610 grams), nonylphenol polyethoxylate (Tergitol NP-4, 2 grams), castor oil polyethoxylate co-polymer (Atlox 4912, 13 grams), sodium bicarbonate (164 grams) corrosion inhibitors (OAI-815, 7 grams and CI-507, 7 grams), petrolatum (IGI-220, 3 grams), Michelman 28430, (39 grams), and a red dye (FD&C 3, 0.03 grams) was added hydroxyethycellulose (Cellosize QP 100-MH, 35 grams). The product was an opaque reddish-pink semi-viscous fluid which became more pink upon thickening. This product removed paint from a wood surface in 140 minutes at 710° F. The product removed paint from a metal surface in less than 30 minutes. The product removed paint from concrete in less than 50 minutes.

What is claimed is:

1. A composition comprising:
from about 5 to about 85 percent by weight aromatic alcohol;
greater that 60 percent by weight water; and
from about 0.05 to about 30 percent by weight electrolyte, based upon 100 percent by weight of the total composition, where the composition is devoid of hydrogen peroxide, and where the electrolyte is selected from the group consisting of Group 1A salts of Group VII elements, Group 1A bicarbonates, Group 1A carbonates, Group 1A metasilicates, Group 1A phosphates, Group 1A pyrophosphates, Group 1A polyphosphates, Group 1B salts of Group VII elements, Group 1B bicarbonates, Group 1B carbonates, Group 1B metasilicates, Group 1B phosphates, Group 1B pyrophosphates, Group 1B polyphosphates, ammonium salts of Group VII elements, ammonium bicarbonates, ammonium carbonates, ammonium metasilicates, ammonium phosphates, ammonium pyrophosphates, and ammonium polyphosphates.

2. The composition of claim 1, where the electrolyte is selected from the group consisting of Group 1A salts of Group VII elements, Group 1A bicarbonates, Group 1A carbonates, Group 1A metasilicates, Group 1A phosphates, Group 1A pyrophosphates, Group 1A polyphosphates.

3. The composition of claim 1, where the electrolyte is selected from the group consisting of Group 1B salts of Group VII elements, Group 1B bicarbonates, Group 1B carbonates, Group 1B metasilicates, Group 1B phosphates, Group 1B pyrophosphates, Group 1B polyphosphates.

4. The composition of claim 1, where the electrolyte is selected from the group consisting of ammonium salts of Group VII elements, ammonium bicarbonates, ammonium carbonates, ammonium metasilicates, ammonium phosphates, ammonium pyrophosphates, and ammonium polyphosphates.

5. The composition of claim 1, where the composition includes from about 0.02 to about 10% by weight of a thixotrope.

6. The composition of claim 5, where the thixotrope is hydroxyethyl cellulose.

7. The composition of claim 1, where the aromatic alcohol is benzyl alcohol.

8. The composition of claim 5, where the aromatic alcohol is benzyl alcohol.

9. The composition of claim 1, where the electrolyte is selected from the group consisting of Group 1A bicarbonates, Group 1B bicarbonates, and ammonium bicarbonates.

10. The composition of claim 1, where the electrolyte is selected from the group consisting of Group 1A phosphates, Group 1B phosphates, and ammonium phosphates.

11. The composition of claim 1, where the electrolyte is a Group 1A bicarbonate.

12. The composition of claim 1, where the electrolyte is an ammonium phosphate.

13. The composition of claim 1, where the composition includes from about 70% to about 80% by weight water.

14. The composition of claim 7, where the electrolyte is selected from the group consisting of Group 1A salts of Group VII elements, Group 1A bicarbonates, Group 1A carbonates, Group 1A metasilicates, Group 1A phosphates, Group 1A pyrophosphates, Group 1A polyphosphates.

15. The composition of claim 7, where the electrolyte is selected from the group consisting of Group 1B salts of Group VII elements, Group 1B bicarbonates, Group 1B carbonates, Group 1B metasilicates, Group 1B phosphates, Group 1B pyrophosphates, Group 1B polyphosphates.

16. The composition of claim 7, where the electrolyte is selected from the group consisting of ammonium salts of Group VII elements, ammonium bicarbonates, ammonium carbonates, ammonium metasilicates, ammonium phosphates, ammonium pyrophosphates, and ammonium polyphosphates.

17. The composition of claim 5, where the electrolyte is selected from the group consisting of Group 1A bicarbonates, Group 1B bicarbonates, and ammonium bicarbonates.

18. The composition of claim 5, where the electrolyte is selected from the group consisting of Group 1A phosphates, Group 1B phosphates, and ammonium phosphates.

19. The composition of claim 5, where the electrolyte is a Group 1A bicarbonate.

20. The composition of claim 5, where the electrolyte is an ammonium phosphate.
